(19) United States
(12) Patent Application Publication
(10) Pub. No.: US 2016/0148164 A1
(43) Pub. Date: May 26, 2016

(54) LOCATION DETECTION DEVICES FOR EVENT SCHEDULING

(71) Applicant: PayPal, Inc., SAN JOSE, CA (US)

(72) Inventors: Bryant Genepang Luk, Round Rock, TX (US); Syed Muasir Khalil, Austin, TX (US); Emil Dides, Coppell, TX (US); Robert He, Pflugerville, TX (US)

(21) Appl. No.: 14/554,885

(22) Filed: Nov. 26, 2014

(51) Int. Cl. G06Q 10/10; H04W 40/28

(52) U.S. Cl. CPC G06Q 10/1095; H04W 40/28

(57) ABSTRACT

There are provided systems and methods for location detection device for event scheduling. A user may plan on attending an event hosted at a venue, such as a movie, sports game, and/or theater production. The user may provide information about the user's location and/or event attendance to a service provider. The information may include a location for the user in relationship to the event so that the service provider may determine a time that the user may arrive at the venue. The information may also be utilized by the service provider to determine a playlist that the user would like to view for the event, such as a list of songs in a concert. Using the information, the service provider may determine a schedule for the event. In one example, the schedule may delay a start time for the event based on the arrival time for the user.

### TECHNICAL FIELD

The present application generally relates to location detection device for event scheduling and more specifically to determining a location of a user through one or more location detection devices, such as communication devices and/or wireless beacons, for use in determining a scheduling for an event hosted at a venue.

### BACKGROUND

Users may attend events at venues that a user has purchased admission for, such as movies, concerts, sports games, theater productions, etc. When attending such an event, the event may have a prescheduled start time to the event. Thus, the user is required to arrive at the event prior to the events start time. However, various occurrences may make an arrival time for the user prior to the start time difficult or impossible. For example, traffic, parking situations, or lines at the event may cause the user's arrival time to the event to be after the event's prescheduled start time. Such situations may also affect a significant portion of the audience for the event. However, without adjusting the event's start time, the user and the other audience members may miss significant amounts of the event. Moreover, if these users have specific requests for the event, such as a favorite song the user wishes to see performed at a concert, the users who are most interested in viewing or experiencing such items in the request may miss their desired items. Thus, the users may have a poor event experience based on the prescheduled start time of the event.

### BRIEF DESCRIPTION OF THE DRAWINGS

FIG. 1 is a block diagram of a networked system suitable for implementing the processes described herein, according to an embodiment;

FIG. 2 is an exemplary environment detecting locations of users with respect to an event at a venue for determining a schedule for the event, according to an embodiment;

FIG. 3 is an exemplary system environment having a communication device providing location and other attendance information to an event server for use in determining an event's schedule communicated to a device at a venue hosting the event, according to an embodiment;

FIG. 4 is a flowchart of an exemplary process used with location detection devices for event scheduling, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods used with location detection devices for event scheduling. Systems suitable for practicing methods of the present disclosure are also provided.

A user may plan on attending an event, such as a movie, concert, sports game, theater production, or other live or recorded event hosted at a venue. The event may have a planned start time to the event that is included in information about the event, such as a schedule for the event, playlist for the event, and/or timeline for the event. The user may possess a communication device which may include various modules of the communication device that may execute specialized hardware and/or software. Such modules may include calendaring/scheduling modules, location modules, and/or communication modules. The user may plan on attending the event and therefore have an arrival time for the event. The user may enter the arrival time to a calendar module of the communication device or may simply begin travel to the event. Thus, a service provider server, such as an event server for the event, may receive attendance information and/or location information for the user. The service provider server may include modules to execute specialized hardware and/or software to determine an arrival time for the user at the event. The arrival time may consider when the user may arrive at the venue or when the user may arrive directly at the event, such as in seats for the event so that the user is viewing or experiencing the event.

When using location information for the user, the arrival time for the user may be determined by factoring in travel time, such as distance from the event, traffic on a travel route that the user is taking to the event, parking time, and/or walking time for a parking structure. The arrival time may also factor in other amounts of time, such as if the user will visit concessions stand, if the user needs to stop for fuel, or other times of delay caused by the user's current status and/or past history of delays. The arrival time may also factor in if other users associated with the first user plan on attending the event and whether the first user will pick up or travel with the associated users to the event. Thus, the arrival time may be determined using additional information, such as information in the aforementioned calendar application of the communication device (e.g., other meeting requests or calendared items), similarly purchased tickets or admission by users associated with the user (e.g., through users who have been co-located with the user, share an account with the user, or have shared transactions with the user), and/or an account history of the user.

The location information may be determined by a location module of the communication device (e.g., a GPS module, a mapping module, and/or a check-in module). The location information may also be entered by the user to the service provider server, such as through a message (e.g., SMS, MMS, e-mail, etc.) or through entry to a website of the service provider server. The location information for the user may also be determined by one or more short range wireless communication devices, such as through beacons using Bluetooth Low Energy (BLE), LTE Direct, or other communication protocol. These beacons may be set up at the venue, such as at or nearby an entrance to the venue, parking lot for the venue, and/or related service for the venue (e.g., nearby restaurants, shuttle services, etc.), or may be established in other locations, such as throughout a town/city associated with the venue, as well as homes/workplaces for users. The beacons may communicate with the communication devices in possession of the user in order to connect to the device and determine the user is in proximity to the beacon. The beacons may provide additional functionality, such as establishing a connection with the service provider server to communicate location information for the user and any additional calendaring or other information utilized to determine the users arrival time. Thus, the beacons may provide proximity detection of users nearby the wireless beacon in order to determine location information for each of those users.

These beacons may communicate with the communication device in possession of the user through Bluetooth Low Energy (BLE), LTE Direct, or another communication protocol receivable by the communication device. When establishing a connection, the beacon may emit a communication signal including an identifier for the beacon, the user, and/or the event or service provider administering the beacons (e.g., a service provider, event/venue administrator, and/or town/city/airport/etc. management associated with a venue or event). A check-in module of the communication device may execute specialized hardware and/or software to passively monitor for the short range wireless communications, for example, through a communication module. When the device detects the signal and verifies the one or more identifiers, both the device and the beacon may ramp up in power and establish a connection, where the connection may further enable the device to communicate additional information to the wireless beacon, such as check-in information (e.g., an identifier) and/or other stored data for the user and/or communication device. The beacon may be connected to a networked device nearby the beacon, or the beacon may include network functionality to communicate with other devices and/or servers itself.

Once the arrival time for the user is determined, the service provider server may access scheduling information for the event. The scheduling information may include a previously scheduled start time for the event, which may correspond to a start time that a manager or hosting party for the event has previously determined that the event should begin. The scheduling information may further comprise a playlist for the event and/or a schedule for occurrences during the event. Using the arrival time for the user, the scheduling information may be adjusted to consider the arrival time for the user, such as by pushing back the start time for the event to provide enough time for the user to arrive at the event. Thus, new scheduling information for the event may be determined by the service provider server. The new scheduling information may not depend just on the arrival time of the user. For example, if only the user will be late to the event based on their arrival time, the start time for the event may not be adjusted. However, if several users, a significant percentage of the users, a majority of the users, and/or all users will be late to the event, the start time may be adjusted accordingly. Further, other attendance information, such as requests and/or desired playlists of the user may affect the schedule for the event during the event. Thus, if the user will be late to the event, the event may continue at the event's previously scheduled start time but a playlist for the event may be revised so that the user does not miss their favorite items in the user's requests/playlist.

If the user is going to be significantly late to the event (e.g., if their arrival time is significantly later than the prescheduled start time for the event), the event may continue as scheduled but the service provider server may offer additional showings to the late user. For example, the service provider server may offer movie tickets to a later showing, concert tickets to the same artist or a similar artist at a different time, a later date for a performance of a theater production, etc. The service provider server may communicate information for the same or similar events at different times to the user with offers for admission to the same or similar events. Further the service provider server may assist the user with purchase of such admission, and may further offer to resell the user's admission to the event that the user will be late in attending. Thus, if the user will be significantly late or cannot attend an event, the user may be adequately compensated with other events and sale of their event tickets.

In contrast, in order to incentivize users to attend the event on time, users whose arrival time and/or location information place the user at the event at or before the prescheduled start time for the event may receive benefits for attending the venue for the event early. Such benefits may include preshow entertainment that the user may be alerted of when travelling to the event. Further, the user may receive discounts, incentives, rebates, or other monetary or item discount for the event and/or the venue. The users may also be offered seat upgrades to users who cannot attend the event, or who have elected to attend another event based on that user's arrival time.

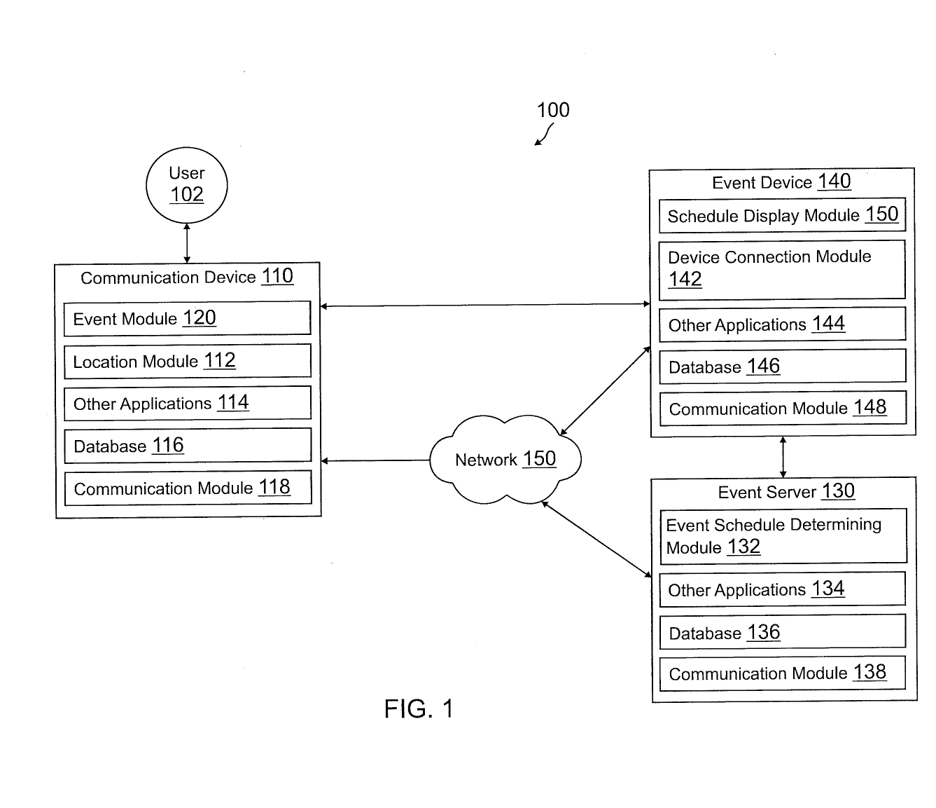

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a communication device 110, an event server 130, and an event device 140 in communication over a network 150. A location for user 102 may be determined using communication device 110, such as through a GPS module or other location module or service provided to user 102 through communication device 110 (e.g., wireless beacons established at a location and used to connect to communication device 110). Event server 130 may receive the location of user 102 and adjust a schedule for an event based on the location of user 102. The adjusted schedule may be sent to event device 140 at the event, for example, located at a venue where the event is hosted. Thus, an administrator, manager, or other entity at the event may utilize the adjusted schedule to change a start time, playlist, or other aspect of the event accordingly.

Communication device 110, event server 130, and event device 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

Communication device 110 may be implemented as a communication device that may utilize appropriate hardware and software configured for wired and/or wireless communication with event server 130, event device 140, and/or other devices/service (e.g., a GPS service provider, a wireless beacon, or other device/server used to determine a location for user 102). For example, in one embodiment, communication device 110 may be implemented as a personal computer (PC), a smart phone, laptop/tablet computer, wristwatch with appropriate computer hardware resources, eyeglasses with appropriate computer hardware (e.g. GOGGLE GLASS®), other type of wearable computing device, and/or other types of computing devices capable of transmitting and/or receiving data, such as an IPAD® from APPLE®. Although a communication device is shown, the communication device may be managed or controlled by any suitable processing device. Although only one communication device is shown, a plurality of communication devices may function similarly.

Communication device 110 of FIG. 1 contains an event module 120, a location module 112, other applications 114, a database 116, and a communication module 118. Event module 120, location module 112, and other applications 114 may correspond to executable processes, procedures, and/or applications with associated hardware. In other embodiments, communication device 110 may include additional or different hardware and software as required.

Event module 120 may correspond to one or more processes to execute modules and associated devices of communication device 110 to purchase and/or maintain admission to an event at a venue, enter user 102's preferences or parameters associated with the event, and/or communicate location information to a server or device managing the event. In this regard, event module 120 may correspond to specialized hardware and/or software utilized by communication device 110 with event device 140 to purchase admission/ticket or enter information for purchased admission/tickets to an event hosted by an entity corresponding to event server 130 and/or event device 140. Event module 120 may therefore include one or more interfaces where user 102 may access event server 130 to purchase the admission, such as through an online ticket sales website or marketplace. Where user 102 purchases physical tickets, for example, from a box office, user 102 may enter ticket information to communication device 110 through event module 120. Thus, event module may receive, access, and/or store, for example to database 116 stored to a non-transitory memory of communication device 110, admission information for an event user 102 is, will, or is planning to attend.

Event module 120 may further be utilized to enter, set, and/or selection information associated with the occurrence of an event for user 102. For example, user 102 may select a playlist for a concert that user 102 will attend, such as a list of songs the user wishes to hear, either ranked by most to least preferred or set into a playlist of an order of songs. In other embodiments, the information entered by user 102 may be associated with a preferred musician to view/hear, teasers or trailers in a movie that user 102 wishes to view, actors or actresses in a theater production that user 102 would like to perform the production, or other selectable options for an event. The information may also be scrapped for another source, such as a media playback application or social networking service. In such embodiments, songs and/or artists that user 102 often listens to may be utilized to set a preferred playlist for a concert. Similarly, comments, interests, or likes from a social networking profile may similarly be utilized to set a playlist, determine desired viewing material, or select preferred performers. In various embodiments, event module 120 may display the predetermined or actual playlist, viewings, and/or performers so that user 102 may vote and/or make selections based on displayed information related to the event, as will be explained in more detail herein.

Event module 120 may also be utilized by event server 130 to determine an expected and/or actual time of arrival for user 102 at the event, for example, at the venue hosting the event and/or in user 102's seats at the venue, as will be explained in more detail herein. In this regard, event module 120 may receive and/or access various information regarding user 102's arrival time for the event and communicate the information to event server 130. Such information may be location information for user 102 and/or communication device 110 determined using location module 112. Other information that may be utilized to determine user 102's arrival time may include calendaring/scheduling information, for example, information entered to a calendar/schedule application of communication device 110. A travel route and/or transportation vehicle utilized by user 102 may further be communication to event server 130. The travel route and/or transportation provider information may further include co-travelers with user 102 and/or stops user 102 is required to make.

Event module 120 may further display event information to user 102 so that user 102 may make selections, vote on event details, or determine an arrival time for the event. As previously discussed, event module 120 may receive a predetermined and/or actual schedule for an event. For example, the entered admission information may be utilized to present to user 102 a predetermined schedule for an event. Event server 130 may be utilized in some embodiments to provide additional event information to user 102. User 102 may view the predetermined schedule and enter in either an expected or actual arrival time for user 102 and/or event occurrence information, such as a playlist for the event. Further users may also enter in such information to event server 130. Once a schedule is adjusted or determined for the event using the received information by event server 130, as will be discussed in more detail herein, the schedule may be communicated to communication device 110 for display to user 102 through event module 120. User 102 may utilize the schedule to further adjust their arrival time or event occurrence information, for example, by requesting or voting on a playlist or song or setting a new arrival time based on the received event schedule (e.g., if user 102 wishes to skip a first musician or set of movie previews based on the highest voted playlist or song(s) by the group of users).

Location module 112 may correspond to one or more processes to execute modules and associated devices of communication device 110 to determine a location for user 102, for example, through a GPS or mapping module and/or through establishing a connection with one or more of wireless beacons established at a location including at or nearby a venue. In this regard, location module 112 may correspond to specialized hardware and/or software utilized by communication device 110 to determine the location of user 102. For example, in certain embodiments, location module 112 may include a GPS module that may interface with a GPS service in order to determine a location for user 102, such as latitude and/or longitude coordinate values. Location module 112 may also include a mapping module that may determine a location for user 102 based on location entries by user 102, connections with one or more nearby locations to user 102, and/or check-in with such location. Location module 112 may further determine a travel route for user 102 based on user 102's entries (e.g., a start point and/or end point), a calendar/schedule for user 102, and/or a location for user 102 and a venue where user 102 may view an event.

In various other embodiments, location module 112 receives short range wireless communications from one or more of wireless beacons through communication module 118 and transmits information to the wireless beacons, including check-in information for a check-in process that associates user 102 with the wireless beacons connected with communication device 110. For example, a wireless beacon may be located at or nearby a venue hosting an event that user 102 is attending and set up to communicate with communication device 110 when communication device 110 is in proximity to the wireless beacon. The wireless beacon may correspond to the venue as a whole or a sub-location/area of the venue, such as an entryway, an admission turnstile, an entry gate, a parking garage, an entrance to an interior of the venue where the event is viewable, a restaurant or other concession area of the venue, a merchandising area of the venue, and/or seating of the venue. Thus, the wireless beacon may be range limited to connect only with devices (e.g., communication device 110) within the specified area, such as a radius around the wireless beacon, a distance away from the wireless beacon, and/or a signal direction for the wireless beacon. When communication device 110 enters the proximity radius for one or more of wireless beacons, communication device 110 and the wireless beacon may connect and check-in information including an identifier for user 102 and/or communication device 110 may be transmitted to the connected wireless beacon.

Location module 112 may execute in the background of an operating system of communication device 110 and be configured to establish connections, using communication module 118 of communication device 110, with one or more of wireless beacons. The connection may be established with or without user input from user 102. For example, wireless beacons may broadcast a token, such as a universally unique identifier (UUID), for reception by location module 112, as will be explained in more detail herein. Location module 112 may utilize communication module 118 of communication device 110 to receive the token from a wireless beacons. If location module 112 acknowledges the UUID as identifying transportation terminal 120, the wireless beacon, event server 130, and/or event device 140 (e.g., if location module 112 determines the UUID corresponds to a request to establish a communication channel and/or process and complete a check-in), location module 112 may transmit an identifier corresponding to user 102 and/or communication device 110 back to the wireless beacon. Location module 112 may utilize communication module 118 of communication device 110 to communicate with the wireless beacon (e.g., over near field communication, Bluetooth, Bluetooth Low Energy, radio, infrared, LTE Direct, or other communication protocol). The identifier from communication device 110 may include, be transmitted with, concatenated with, or otherwise bundled with the identifier received from the wireless beacon. Thus, the wireless beacon may identify the communication as associated with a connection request by the wireless beacon. In other embodiments, different information may be transmitted to the wireless beacon, such as an identifier for user 102, a name or other personal information for user 102, or other identifying information. Thus, the information transmitted to the wireless beacon does not need to be utilized to process and/or complete a check-in in all embodiments.

Once a connection is established with a wireless beacon, the process may associate user 102 with the wireless beacon used to connect to communication device 110. For example, the wireless beacon may previous be registered as located at or nearby the venue, including in sub-areas associated with the venue as previously discussed. Once communication device 110 connects to the wireless beacon, the connection information may be transmitted to event server 130 in order to locate user 102 at the area associated with the wireless beacon. As previously discussed, wireless beacons may also be associated with a large area associated with a venue, such as a city/town, and thereby locate user 102 within the larger area for use by event server 130. Event server 130 may process the connection/location information to determine a schedule for an event, as will be explained in more detail herein.

In various embodiments, communication device 110 includes other applications 114 as may be desired in particular embodiments to provide features to communication device 110. For example, other applications 114 may include security applications for implementing client-side security features, programmatic client applications for interfacing with appropriate application programming interfaces (APIs) over network 150, or other types of applications. Other applications 114 may also include email, texting, voice and IM applications that allow a user to send and receive emails, calls, texts, and other notifications through network 150. In various embodiments, other applications 114 may include financial applications, such as banking, online payments, money transfer, or other applications associated with a payment provider. As previously discussed, other applications may include mapping, travel, calendaring/scheduling, Internet browser applications, or other applications, which, for example, may be utilized to determine an arrival time for user 102 at an event and, thus, a schedule for the event by event server 130. Other applications 114 may include device interfaces and other display modules that may receive input from user 102 and/or output information to user 102. For example, other applications 114 may contain software programs, executable by a processor, including a graphical user interface (GUI) configured to provide an interface to the user.

Communication device 110 may further include database 116 stored to a transitory and/or non-transitory memory of communication device 110, which may store various applications and data and be utilized during execution of various modules of communication device 110. Thus, database 116 may include, for example, identifiers such as operating system registry entries, cookies associated with event module 120, location module 112, and/or other applications 114, identifiers associated with hardware of communication device 110, or other appropriate identifiers, such as identifiers used for payment/user/device authentication or identification. Database 116 may include location information, travel route information, calendaring/scheduling information, personal information, or other information that may be communicated to event server 130 to determine an arrival time for user 102 at an event. Database 116 may include connection and/or check-in information for user 102. Furthermore, database 116 may further include received information from event server 130, for example, a predetermined schedule for an event and/or an adjusted schedule for the event based on one or more arrival times and/or playlists for users attending the event.

Communication device 110 includes at least one communication module 118 adapted to communicate with one or more wireless beacons, event server 130, and/or event device 140. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 118 may communicate directly with one or more wireless beacons using short range communications, such as Bluetooth Low Energy, LTE Direct, WiFi, radio frequency, infrared, Bluetooth, and near field communications.

Event server 130 may be maintained, for example, by a service provider, which may provide management of events and/or venues hosting events for one or more parties. For example, event server 130 may correspond to or be associated with a movie theater company, an owner of a stadium/amphitheater/concert hall/etc., or event server 130 may be associated with a management company hosting an event at one of the aforementioned venues. In this regard, event server 130 includes one or more processing applications which may be configured to interact with communication device 110 and/or event device 140 to provide event scheduling services for the event. Although only one server is shown, a plurality of servers and/or associated devices may function similarly. Although event server 130 is described as a server device, in various embodiments, event server 130 may function as a specialized device local to the event and/or event venue. Thus, although event server 130 is shown as separate from event device 140, the below described modules, hardware, and functions may be included within one device/entity, such as event device 140.

Event server 130 of FIG. 1 includes an event schedule determining module 132, other applications 134, a database 136, and a communication module 138. Event schedule determining module 132 and other applications 134 may correspond to executable processes, procedures, and/or applications with associated hardware. In other embodiments, event server 130 may include additional or different hardware and software as required.

Event schedule determining module 132 may correspond to one or more processes to execute modules and associated devices of event server 130 to determine a schedule for an event using location information and/or event occurrence information retrieved for user 102 and/or a plurality of other users. In this regard, event schedule determining module 132 may correspond to specialized hardware and/or software utilized by event server 130 with communication device 110 and/or event device 140 to receive the location information and/or event occurrence information, access a first schedule for the event from one of database 136 stored to a non-transitory memory of event server 130. Thus, event schedule determining module 132 may first receive location information for user 102. As previously discussed, the location information may be determined by communication device 110 (e.g., through GPS and/or mapping modules and/or services) or may be determined using connections between communication device 110 and one or more wireless beacons. The location information for user 102 may be received by event schedule determining module 132 for processing by event server 130. As previously discussed, the location information may include direct coordinates or map locations for user 102, travel routes for user 102, and/or planned locations user 102 is travelling to, such as locations designated in a schedule/calendar for user 102. The location information may also include locations of users associated with user 102, such as friends travelling to a concert with user 102. For example, user 102 may be required to pick up such a friend when travelling to the concert. Event schedule determining module 132 may further receive event occurrence information for user 102, such as a playlist of songs user 102 may wish to hear at a concert, a preferred musician or performer user 102 may wish to view, and/or movie trailers or other video user 102 may wish the experience. Event schedule determining module 132 may receive the aforementioned location and/or event occurrence information from a plurality of other users in addition to user 102, in various embodiments. Thus, event schedule determining module 132 may receive a plurality of different location information and/or event occurrence information.

Event schedule determining module 132 may utilize the location information and/or event occurrence information to determine a schedule for an event that user 102 is attending. Event schedule determine module 132 may determine an initial schedule based on the location and/or event occurrence information, in certain embodiments. In such embodiments, a previous schedule for the event may not have been determined. Thus, event schedule determining module 132 may wait to gather the location and/or event occurrence information prior to determining the schedule for the event. The schedule may include a start time for the event, an end time for the event, a playlist or schedule determining how the event will occur, and/or performers scheduled to perform in the event. However, in other embodiments, an initial schedule for the event may have been determined, such as a set start time, end time, playlist/schedule for the event, and performers in the event. Thus, the location and/or event occurrence information for user 102 may adjust the initial/predetermined schedule for the event such that the start time, end time, playlist, and/or performers are changed based on the location and/or event occurrence information for user 102. As previously discussed, event schedule determining module 132 may receive location and/or event occurrence information for a plurality of user in addition to user 102 in order to adjust the event schedule based on each users' location and/or event occurrence information.

For example, user 102's location information may place user 102 as a 10 minute travel from a venue hosting an event, 10 miles away from the event, or with a calendared item occurrence 10 minutes into the event. Thus, event schedule determining module 132 may determine that user 102 may be X minutes late to the event. Based on such information, event schedule determining module 132 may delay the event by X minutes to allow user 102 time to arrive at the event and not miss part of the event. Furthermore, user 102's event occurrence information may affect the playlist or schedule for the event. For example, event occurrence information for user 102 may include information related to songs or performances user 102 wishes to experience. If user 102 does not care to hear a certain song, event schedule determining module 132 may place such a song at the forefront of the playlist for the event so that if user 102 is X minutes late, they may miss the song but otherwise not miss desired performances during the event. In other embodiments, the playlist for the event may be adjusted even if user 102 is on time to the event, such as by removing an item from a schedule that user 102 doesn't wish to experience. User 102 may also be alerted of when certain items from the playlist that user 102 does not wish to experience are occurrence so that user 102 may visit a restroom, concessions stand, or merchandise shop.

Of course, with an event having hundreds, thousands, or more attendees, delay of the event and/or adjustment of event schedules may be unmanageable or undesirable for a single user. Thus, event schedule determining module 132 may only delay the event if a sufficient amount of the users attending the event will be late to the event based on their location and/or event occurrence information. For example, an accident in a parking garage or on a road leading up to an event may delay a significant percentage or a majority of users from attending an event. Thus, event schedule determining module 132 may set a number or percentage of users required to be late to an event before event schedule determining module 132 may adjust a schedule for the event, such as a start time and/or playlist for the event.

Event schedule determining module 132 may also receive event occurrence information from a plurality of users that all include desired experiences, viewings, or other occurrences to happen during an event. For example, a plurality of users attending a concert may set a playlist for the concert and/or preferred performers to play at the concert. Event schedule determining module 132 may process each user's event occurrence information to determine a schedule for the event. The schedule for the event may consider the most preferred playlist for all of the users submitting a playlist, but may not necessarily be optimized to one particular user's playlist. In this manner, event schedule determining module 132 may set a playlist and/or schedule of performers that accurately reflects an audience or crowds overall desired schedule for the event.

Once a schedule for an event is determined by event schedule determining module 132, the schedule may be communicated to communication device 110 and/or event device 140. User 102 may adjust the schedule further using input to communication device 110, as previously discussed. For example, user 102 may vote further on a start time or playlist for an event that may further be utilized by event schedule determining module 132 to further adjust the schedule for the event. User 102 may set further information, such as a request to begin the event without user 102. Additionally, if user 102 is unable to attend the event, user 102 may enter a request to cancel, refund, or exchange admission to the event to communication device 110. In certain embodiments, event schedule determining module 132 may determine user 102 will be so late to the event, that user 102 is better advised to miss the event and/or reschedule for a future event. In such embodiments, event schedule determining module 132 may assist user 102 in refunding, reselling, cancelling, and/or exchanging admission to the event. Thus, event schedule determining module 132 may offer ticket sales and/or management services. Event schedule determining module 132 may determine one or more same or similar events that may occur at a future time and communicate the same or similar events to user 102. The same or similar events determined by event schedule determining module 132 may be determined based on the missed event, user 102's schedule, and/or user 102's current or future location. Event schedule determining module 132 may further receive a request for a purchase or exchange of present admission for admission to the future same or similar event and process such a request.

Event schedule determining module 132 may further offer incentives to user 102 to be on time to an event or if user 102 is early to an event. For example, event schedule determining module 132 may detect user 102 is at or nearby the event prior to the event's predetermining scheduled start time. In such embodiments, event schedule determining module 132 may offer a discount, pre-event showing, free item, or other incentive for user 102 to be at the event (e.g., in user 102's seat) prior to or at the event's start time. Event schedule determining module 132 may determine such incentives based on the event and/or nearby concessions, restaurants, or merchandise near the event (e.g., at or nearby a venue for the event). The incentives may be communicated to communication device 110 or may be given to user 102 only when user 102 is physically present at the event (e.g., by a representative or employee at the venue and monitoring seating for the event).

In various embodiments, event server 130 includes other applications 134 as may be desired in particular embodiments to provide features to event server 130. For example, other applications 134 may include security applications for implementing server-side security features, programmatic server applications for interfacing with appropriate application programming interfaces (APIs) over network 150, or other types of applications. Other applications 134 may contain software programs, executable by a processor, including a graphical user interface (GUI), configured to provide an interface to a user.

Additionally, event server 130 includes database 136 store to a non-transitory memory of event server 130. In various embodiments, event server 130 allow user 102 to establish user accounts with event server 130 that may include user information, such as admission information for an event, scheduling/calendar information, or other location and/or event occurrence information. However, in other embodiments, event server 130 may instead receive such information and store the aforementioned information with an identifier for user 102 for use by event schedule determining module 132. Database 136 may further include schedule information for an upcoming event, including predetermined schedule information, initial schedule information determined using user location and/or occurrence information, and/or adjusted schedule information.

In various embodiments, event server 130 includes at least one communication module 138 adapted to communicate communication device 110 and/or event device 140 over network 150. Communication module 138 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Event device 140 may be implemented as a communication device that may utilize appropriate hardware and software configured for wired and/or wireless communication with communication device 110, one or more wireless beacons, and/or event server 130. Event device 140 may be located locally to an event, such as at a venue for the event. Event device 140 may be utilized to present and/or manage a schedule for an event. For example, in one embodiment, event device 140 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, display device include processing components, heads up display device, vehicle dashboard or console device, and/or other types of computing devices capable of transmitting and/or receiving data, such as an IPAD® from APPLE®. Although an event device is shown, the event device may be managed or controlled by any suitable processing device. Although only one event device is shown, a plurality of event devices may function similarly.

Event device 140 of FIG. 1 contains a schedule display module 150, device connection module 142, other applications 144, a database 146, and a communication module 148. Schedule display module 150, device connection module 142, and other applications 144 may correspond to executable processes, procedures, and/or applications with associated hardware. In other embodiments, event device 140 may include additional or different hardware and software as required.

Schedule display module 150 may correspond to one or more processes to execute modules and associated devices of event device 140 to receive information from event server 130 and display such information to one or more administrators of an event for use with scheduling and/or presenting the event. In this regard, schedule display module 150 may correspond to specialized hardware and/or software utilized by event device 140 to receive scheduling information, such as a predetermined schedule, an initially determined schedule using location information and/or event occurrence information for one or more users (including user 102), and/or an adjusted schedule. Schedule display module 150 may receive the scheduling information from event server 130 after the schedule is determined by event server 130 and utilize the schedule to arrange an event. For example, the schedule may include a start time for the event, an end time for the event, intermissions or other breaks during the event, a play list for the event, and/or performers in the event. Schedule display module 150 may display the schedule to one or more performer in the event, such as using a display module including a user interface. Schedule display module 150 may also utilize additional hardware and/or software to arrange settings for the event, such as lighting, sound, special effects, or other controllable output during the event.

Device connection module 142 may correspond to modules and associated devices of event device 140 to establish a connection with communication device 110, for example, to determine a location for user 102 and/or provide incentives to user 102 from event server 130. In this regard, schedule display module 150 may correspond to specialized hardware and/or software utilized by event device 140 to form a connection with communication device 110, such as through one or more wireless beacons. Device connection module 142 may connect with communication module 110 using communication module 148 and communicate information to communication device 110, such as a predetermined, initial, and/or revised/updated schedule for an event associated with event device 140. Further, device connection module 142 may provide incentives for user 102 to be on time to an event and/or be located in their seat at an exact or approximate starting time for an event. Device connection module 142 may further communicate a benefit to communication device 110 if user 102 is on time to the event.

Where device connection module 142 includes one or more wireless beacons, the wireless beacons may be maintained, for example, by a service provider, venue management, and/or event server 130. Wireless beacons may be implemented using any appropriate hardware and software configured for wireless communication with communication device 110, event server 130, and/or event device 140. For example, in one embodiment, wireless beacons may be implemented as a dongle device including a hardware processor and a communication module, for example, connected to a device at transportation terminal 120 (e.g., a computing device having specialized hardware and/or software for management of transportation services). Wireless beacons may also be implemented as a device incorporated within a personal computer (PC), a smart phone, laptop computer, and/or other types of computing devices capable of transmitting and/or receiving data, such as an IPAD® from APPLE®. Wireless beacons may also act as a stand-alone device including a processor, communication module, and/or network interface component configured to communicate with communication device 110, event server 130, and/or event device 140. Thus, wireless beacons may be integrated within event device 140 or may correspond to external device connected with event device 140. Although a plurality of wireless beacons are described, a single wireless beacon may be utilized at the transportation terminal.

Wireless beacons may be located at and throughout a venue corresponding to event device 140. In other embodiments, wireless beacons may be located external to the venue, for example, in nearby locations associated with the venue (e.g., restaurants, parking garages, etc.) or a wider location corresponding to the venue (e.g., a city/town for the venue). Wireless beacons of FIG. 1 contains processes, procedures, and/or applications, for example, a software program, executable by a hardware processor configured to interact with communication device 110, event server 130, and/or event device 140. Thus, regardless of the implementation of wireless beacons, as discussed above, each of wireless beacons utilize a check-in module and may include a communication module or may utilize communication module 148 of event device 140. The check-in module may correspond to executable processes, procedures, and/or applications with associated hardware. In other embodiments, wireless beacons may include additional or different software and devices as required.

The check-in module may correspond to an executable module having specialized hardware and/or software features for transmitting requests to establish a connection between a device (e.g., communication device 110) and a wireless beacon transmitting the request to establish the connection. Thus, the wireless beacon may utilize short range wireless communications of the wireless beacon to transmit the requests to establish a connection, including an identifier such as a Universally Unique Identifier (UUID). If communication device 110 receives a request to establish the connection with the wireless beacon and responds with a communication device identifier (potentially including the UUID and other information necessary to effectuate a check-in of communication device 110), the check-in module may cause the wireless beacon to ramp up in power and create a connection between communication device 110 and the wireless beacon.

Each wireless beacon may transmit the request to establish the connection with the wireless beacon as a short range wireless communication (e.g. a BLE protocol communication) including a “wake up” process for location module 112 of communication device 110 and/or a token for the wireless beacon. In other embodiments, the request and/or connection may utilize near field communication, radio communication, infrared communication, Bluetooth communication, or WiFi communication. Additionally, although the wireless beacon may utilize BLE protocol communications to effectuate an “always on” type service where the UUID and “wake up” process are transmitted continuously, other communication protocols used to provide an “always on” service may include QUALCOMM® LTE Direct or similar device-to-device communication technology. BLE and LTE Direct may both be utilized to provide discovery of nearby devices to the wireless beacon (e.g., communication device 110) and establishment of a connection for data transfers.

The request may be specific to communication device 110 by including information that is specific to user 102, such as a name, identifier, or communication device identifier. The information specific to user 102 may be determined from a user account of user 102 or other information previously provided to event server 130 and/or event device 140. Thus, in certain embodiments, only communication device 110 will pick up and authenticate the request. After the check-in module receives a communication device identifier from communication device 110, the check-in module may determine user 102 is in proximity to the wireless beacon connected to communication device 110. The wireless beacon that connected to communication device 110 may pass the communication device identifier to event server 130 using the check-in module. Thus, event server 130 may determine communication device 110 is in proximity to the wireless beacon connected to communication device 110 through the connection between communication device 110 and the connected wireless beacon, as will be discussed in more detail herein. Additionally, the check-in module may cause wireless beacons to keep a communication channel open with communication device 110 for passing additional information between communication device 110 and event server 130. Such as incentives, event schedules, or other information. However, in other embodiments, event server 130 and/or event device 140 may pass such information directly to communication device 110, as previously discussed.

In various embodiments, each of the wireless beacons may include a communication module or utilize communication module 148 to communicate with communication device 110, event server 130, and/or event device 140. The communication module may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. The communication module may communicate with communication device 110 using short range communications, such as radio frequency, infrared, Bluetooth, and near field communications.

In various embodiments, event device 140 includes other applications 144 as may be desired in particular embodiments to provide features to event device 140. For example, other applications 144 may include security applications for implementing client-side security features, programmatic client applications for interfacing with appropriate application programming interfaces (APIs) over network 150, or other types of applications. Other applications 144 may include device interfaces and other display modules that may receive input from an administrator for the transportation service associated with event device 140 and/or output information to the administrator. For example, other applications 144 may contain software programs, executable by a processor, including a graphical user interface (GUI) configured to provide an interface to the administrator.

Event device 140 may further include database 146 stored to a transitory and/or non-transitory memory of event device 140, which may store various applications and data and be utilized during execution of various modules of event device 140. Thus, database 146 may include, for example, identifiers such as operating system registry entries, cookies associated with schedule display module 150, device connection module 142, and/or other applications 144, identifiers associated with hardware of event device 140, or other appropriate identifiers, such as identifiers used for payment/user/device authentication or identification. Database 146 may include information received from communication device 110 and/or event server 130. For example, database 146 may include scheduling information for an event, such as a predetermined, initial, and/or revised schedule for hosting the event. Database 146 may further include connection/check-in information for user 102/communication device 110, such as an identifier, as well as incentives and benefits for an event.

Event device 140 includes at least one communication module 148 adapted to communicate with wireless beacons, communication device 110, and/or event server 130. In various embodiments, communication module 148 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 148 may communicate directly with wireless beacons, communication device 110, and/or event server 130 using short range communications, such as Bluetooth Low Energy, LTE Direct, WiFi, radio frequency, infrared, Bluetooth, and near field communications.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

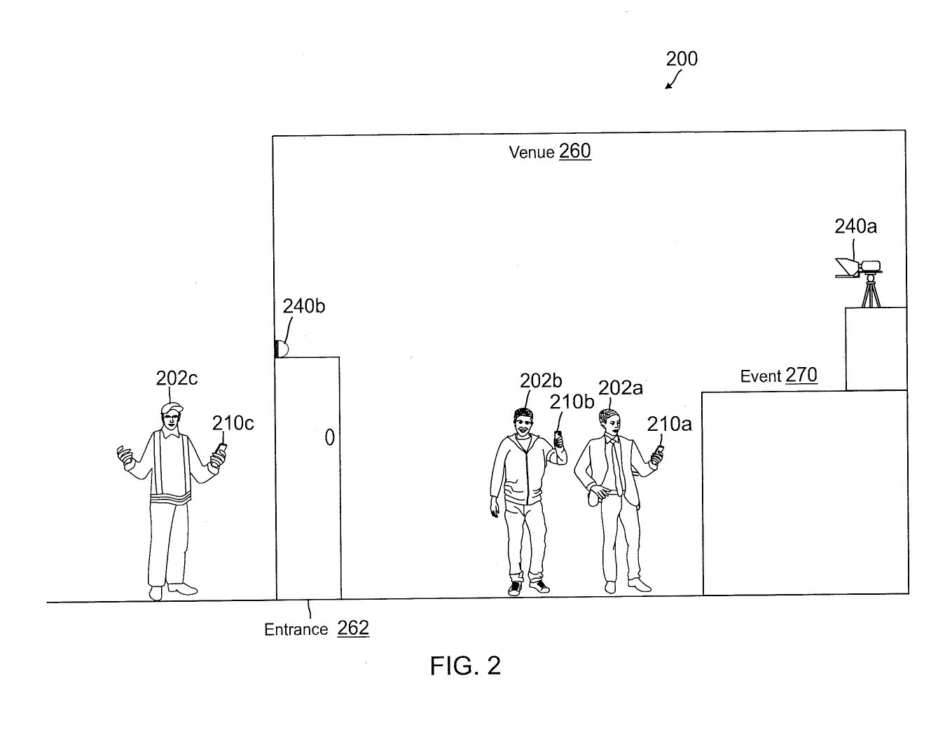

FIG. 2 is an exemplary environment detecting locations of users with respect to an event at a venue for determining a schedule for the event, according to an embodiment. Environment 200 of FIG. 2 includes a user 202a having a communication device 210a, a user 20b having a communication device 210b, and a user 202c having a communication device 210c all corresponding generally to user 102 and communication device 110, respectively, of FIG. 1. Environment 200 also includes an event device 240a and an event device 240b corresponding generally to event device 140 of FIG. 1.

Users 202a-c plan to attend an event 270 at a venue 260. Thus, users 202a-c may be travelling to and/or arriving at venue 260 in order to view/experience event 270 when event 270 is performed. As shown in environment 200, each of users 202a-c arrive at venue 260 at different times. For example, users 202a and 202b are already at venue 260, while user 202c is still arriving at venue 260 and has yet to pass through entrance 262 at venue 260. Additionally, while users 202a and 202b are at venue 260, one or both of users 202a and 202b may have yet to arrive in their seats at venue 260 and be ready to view event 270. The location of each user and/or other information (e.g., schedule information and/or event occurrence information) may be received and/or determined by communication devices 210a-c in possession of users 202a-c, respectively. In various embodiments, the locations of users 202a-c may be received from communication device 210a-c, such as through a GPS module and having GPS coordinates. In further embodiments, the locations for users 202a-c may also be determined using connections established by communication device 210a-c with other devices, such as an event device 240b (e.g., a wireless beacon). Thus, event device 240b may form a connection with each of communication devices 202a-c when communication device 210a-c are in proximity to event device 240b (e.g., when users 202a-c pass through entrance 262 at venue 260 with communication devices 210a-c).

Thus, in order to determine a schedule for event 270, an event server administering event 270 may determine locations for users 202a-c in order to determine a schedule for event 270. The locations of users 202a-c may be utilized to determine how long of a period of time users 202a-c need in order to be able to be ready to view event 270. Further, the schedule may be determined using other information, such as a personal schedule of users 202a-c (e.g., if users 202a-c may require additional time to be ready for event 270 due to personal obligations). Thus, the event server may determine that while users 202a and 202b are ready to view event 270 currently, user 202c may require an additional 10 minutes to pass through entrance 262 and be seated at user 202c's seats in venue 260. In such an embodiment, the event server may delay the start of event 270 for the 10 minutes required by user 202c so that user 202c does not partially view the event.

Of course, if users 202a and 202b are ready to view event 270 and only user 202c is late for event 270, the event server may determine to start event 270 without user 202c. In such an embodiment, user 202c may be offered additional or alternative admission to the same or similar event to event 270 at a later time. Such offer may be communicated to communication device 210c for user 202c. The event server may also offer to refund, exchange, or sell admission user 202c has to event 270. Moreover, users 202a and 202b may be offered incentives or benefits for being on time to event 270, for example, through their communication devices 210a and 210b. Such incentives and/or benefits may correspond to event 270 (e.g., a discount, preshow entertainment, etc.) or may correspond to venue 260 or another event (e.g., a discount, free item, etc.).

The schedule for the event may be communicated to event device 240a for use in executing event 270. Event device 240a may choose to begin event 270 (e.g., through starting a movie, show, etc.) or may present the schedule on a display module/interface of event device 240a to an administrator/manager/performer of event 270. As previously discussed, the schedule may have various start, pause, and/or end times, playlists, and/or performer/performance requests. The schedule may also be communicated to one or more of communication device 210a-c. Thus, users 202a-c may view the schedule and may also further vote on the schedule using communication device 210a-c.

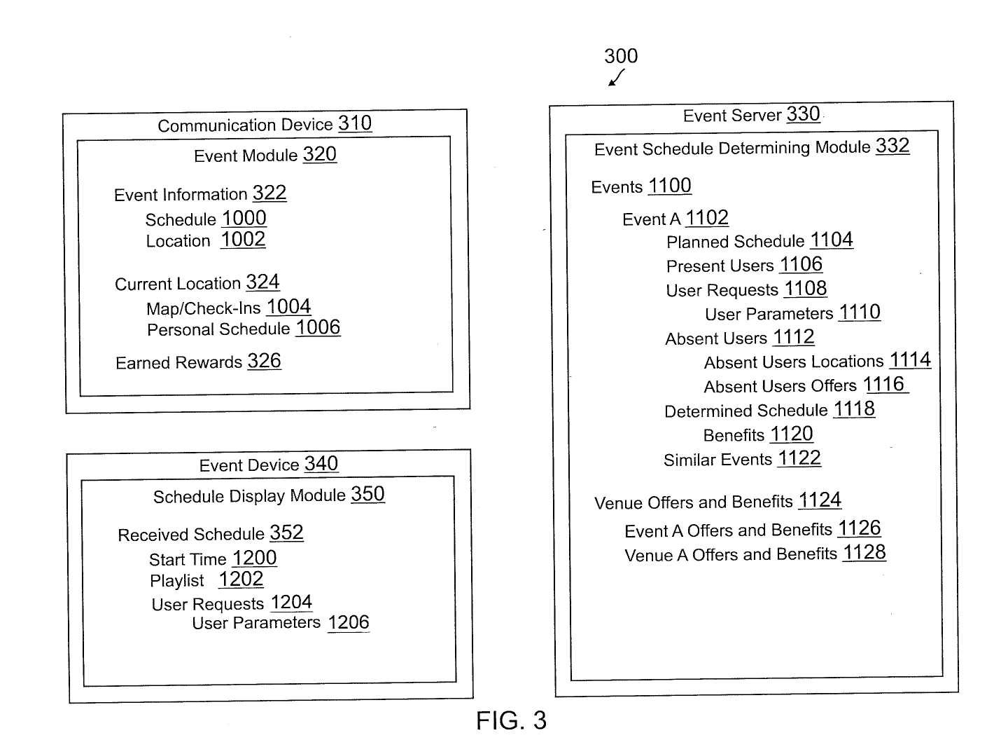

FIG. 3 is an exemplary system environment having a communication device providing location and other attendance information to an event server for use in determining an event's schedule communicated to a device at a venue hosting the event, according to an embodiment. Environment 300 of FIG. 3 includes a communication device 310, an event server 330, and an event device 240 corresponding generally to communication device 110, event server 130, and event device 140, respectively, of FIG. 1.

Communication device 310 executes an event module 320 corresponding generally to the specialized hardware and/or software modules and processes described in reference to event module 120 of FIG. 1. In this regard, event module 320 may be utilized to receive enter event admission information and/or desired event occurrence information (e.g., a playlist for an event), communication location information and/or the event occurrence information, and receive event scheduling information, incentives for the event, and/or future admission to the same or similar event. Thus, event module 320 includes event information 322, currently location 324, and earned rewards 326. Event information 322 may correspond to entered admission information and/or schedule information for an event as well as received information. Event information 322 therefore includes a schedule 1000 and a location 1002. Schedule 1000 includes a schedule for the event, such as a predetermined, initial, and/or revised schedule for an event. Location 1002 may also include location information for the event, such as a physical address of a venue for the event.

Current location 324 in event module 320 may correspond to the location information for the user of communication device 310 (not shown). Thus, currently location 324 may be associated with the GPS coordinates, map location, and/or connection/check-in information for the user and communication device 310. Current location 324 therefore includes map/check-ins 1004, which include the GPS coordinates, map location, and/or connection/check-in information. Current location 324 may also include a person schedule 1006 for the user, which may correspond to locations the user may travel to and/or obligations of the user. Finally event module 320 includes earned rewards 326, which may correspond to incentives and benefits that the user has accrued with respect to an event by virtue of their timeliness to the event.

Event server 330 executes an event schedule determining module 332 corresponding generally to the specialized hardware and/or software modules and processes described in reference to event schedule determining module 132 of FIG. 1. Thus, event schedule determining module 322 includes information for events 1000 as well as venue offers and benefits 1124. Events 110 may include information for one or more upcoming or currently occurring events that users may view/experience. In this regard, events 1100 includes an event A 1102 having a planned schedule 1104, present users 1106, user requests 1108, absent users 1112, a determined schedule 1118, and similar events 1122. Using the information available for event A 1102, a schedule may be determined or adjusted for event A 1102. Thus, event A may start with a planned schedule 1104 or may not have an initially determined schedule. Event schedule determining module 332 may utilize present users 1106 at the event (e.g., at the venue) with absent users 1112 to determine a start time, pause time, and/or end time for the event. Absent users 1112 includes absent users' locations 1114 and absent users' offers 1116. For example, a start time may be determined to give absent users 1112 time to reach the event from the users' locations in absent users' locations 1114. Therefore, determined schedule 1118 may include such a schedule. Determined schedule 1118 may also include a playlist of performers and/or performances. Such a playlist may be determined using user requests 1108. User requests 1108 may include user parameters, such as a list of favorite songs and/or musicians. User parameters 1110 may also include votes or requests for certain performers/performances.

In other embodiments, it may be determined by event schedule determining module 332 that an absent user in absent users 1112 cannot attend event A 1102 (e.g., through absent users' locations 1114. Thus, event schedule determining module 332 may determine absent users' offers 1116 for absent users 1112. Absent users' offers 1116 may include information for the same or similar event to event A 1102 at a future time, such as another showing of event A 1102. Absent users' offers 1116 may be determined using similar events 1122 having information about future showings of the same or similar event to event A 1102. In contrast to absent users 1112, determined schedule 1118 may also include benefits 1120 extend to users that are on time to event A 1102. Benefits 1120 may be determined using venue offers and benefits 1124, such as event A offers and benefits 1126 for offers associated with event A 1102 and/or venue A offers and benefits 1128 for offers associated with a venue A hosting event A 1102.

Once event schedule determining module 332 generates determined schedule 1118, determined schedule 1118 may be communicated to event device 340. Schedule display module 350 may display determined schedule 1118 and/or execute event A using determined schedule 1118. For example, determined schedule may be presented to an administrator of event A so that received schedule 352 is displayed to the administrator. Received schedule 352 may include a start time 1200, a playlist 1202, and user requests 1204 having user parameters 1206. Although received schedule 352 is described as the same as determined schedule 1118 (e.g., determined using user location and/or event occurrence information), in various embodiments, received schedule 352 may correspond to a predetermined schedule, such as planned schedule 1104.

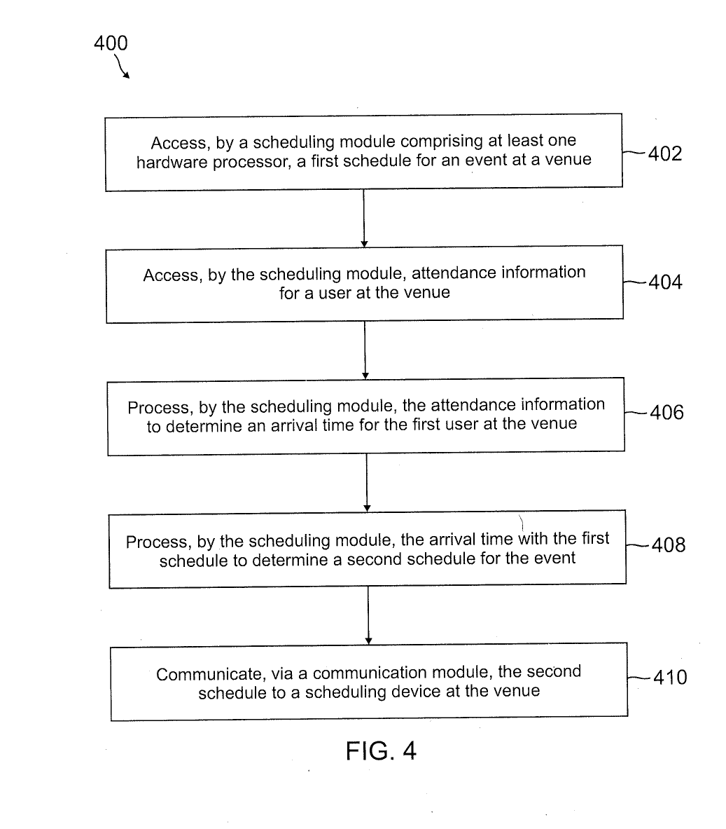

FIG. 4 is a flowchart of an exemplary process used with location detection devices for event scheduling, according to an embodiment. Note that one or more steps, processes, and methods described herein may be omitted, performed in a different sequence, or combined as desired or appropriate, as well as be performed by different modules, entities, components, or systems.

At step 402, a first schedule for an event at a venue is accessed, for example, by a scheduling module comprising at least one hardware processors. The first schedule may include a start time, a stop time, a playlist of performances and/or performers, intermission times, or other required information for the execution of an event. In other embodiments, a first schedule may not be accessed and instead a schedule may be required to be determined by the scheduling module. A venue may host the event and include one or more wireless beacons used to connect to a device of a user. Thus, at step 404, attendance information for the user at the venue may be accessed by the scheduling module. The attendance information may include location information and/or event occurrence information for the user, such as a location and a playlist for the user. The location information for the user may be determined using the wireless beacons, such as through connections to a communication device of the user. The location information may also be determined using a GPS module and/or mapping service used by the first user with the communication device or through network connection of the communication device.

The attendance information is processed, by the scheduling module, to determine an arrival time for the first user at the venue, at step 406. The arrival time may provide sufficient time for the first user to arrive at the venue in order to view/experience the event. Thus, the arrival time may correspond to a time to start the event that is later than the start time in the first schedule. Thus, at step 408, the arrival time is process, by the scheduling module, with the first schedule to determine a second schedule for the event. In various embodiments, second location information for one or more second users may be accessed and the second schedule may be determined using the second location information. In such embodiments, the second schedule may not adjust the start time to be later than the initial start time in the first schedule, or may adjust the second schedule to take into account the arrival times of the one or more second users. At step 410, the second schedule is communicated, via a communication module, to a scheduling device at the venue. As previously discussed, the second schedule may include a start time, stop time, playlist, etc. Thus, the scheduling device may utilize the schedule to perform the event.

The user may be incentivized to be on time to the event through an offer determined by the scheduling module. The offer may include a benefit comprising at least one of a preshow for the event, a discount for a purchase at the venue, at least one additional ticket to one of the venue and a related event. However, if the user is going to be sufficiently late to the event, the user may be offered at least one of a first showing of a same event after the event and a second showing of a similar event after the event. The offer may include a sale of at least one ticket to at least one of the first showing and the second showing. The offer may also be to resell at least one ticket for the event purchased by the first user.

Changing the start time, the playlist, and/or other aspects of the event may also consider information associated with users. For example, the event may more likely be changed if the user is a die-hard fan, an influential person, such as a blogger or reviewer, etc., as opposed to the user being a casual fan of the performer, such as possibly only attending because the user received the ticket as a gift or at a very low price.

Users as described above can be individuals or more generalized groups. For the latter, one user may be a group estimated to be X minutes late and having an interest in a certain song(s) or playlist. Another user may be a group also estimated to be X minutes late and composed of loyal or fan club members of the performers. Yet another user may be Y minutes late and be a group of first-time people seeing the performer. Another user may be on time and recently bought the newest album of the performers. [If not covered, consider one or more dependent claims on the added material.]

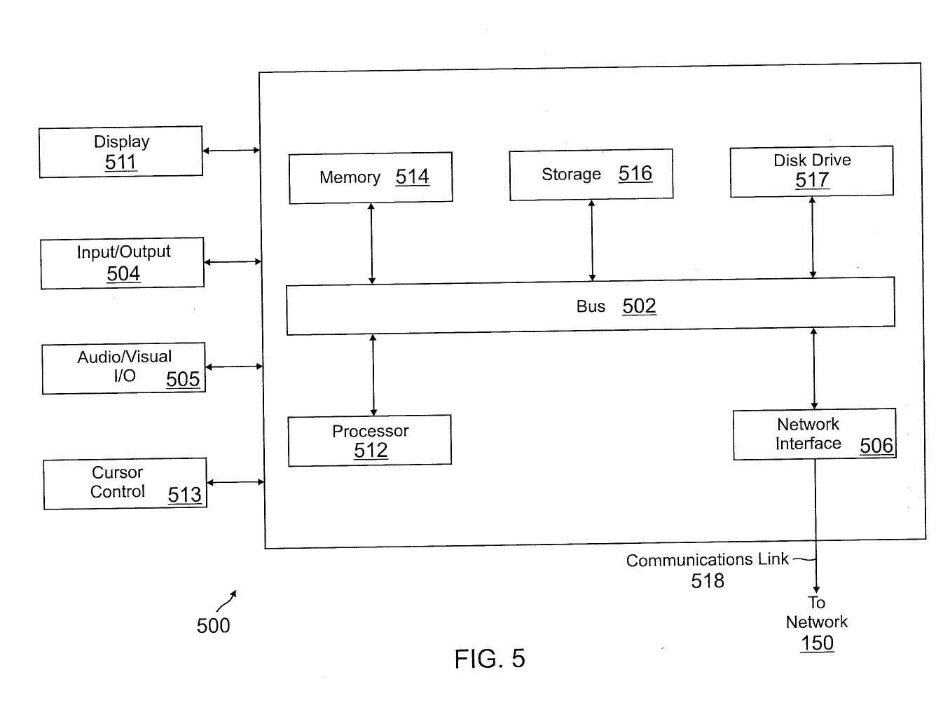

FIG. 5 is a block diagram of a computer system suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 150. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
an event schedule determining module comprising at least one hardware processor that accesses event scheduling information for an event and first location information for a first user attending the event, determines a first arrival time for the first user at the event using the first location information, and determines a first schedule for the event using the event scheduling information and the first arrival time;
a database, stored to a non-transitory memory, comprising the first location information and the event scheduling information; and
a communication module that receives the first location information for the first user and communicates the schedule to an event scheduling device associated with the event.

2. The system of claim 1, wherein the communication module receives the first location information from a communication device for the first user, and wherein the communication device determines the first location information using at least one of a network connection to a location services server, a GPS module, and a mapping application.

3. The system of claim 1, wherein the communication module further receives second location information for the first user, and wherein the event schedule determining module accesses the second location information, determines a second arrival time for the first user, and updates the first schedule using the using the second arrival time.

4. The system of claim 1, wherein the communication module further receives second location information for a second user attending the event, and wherein the event schedule determining module accesses the second location information, determines a second arrival time for the second user at the event using the second location information, and determines a second schedule for the event using the event scheduling information, the first arrival time for the first user, and the second arrival time for the second user.

5. The system of claim 1, wherein the first schedule comprises a time to start the event.

6. The system of claim 5, wherein the time to start the event is later than a previously scheduled time to start the event in the event scheduling information, and wherein the time to start the event provides an amount of time to allow the first user to arrive at the event.

7. The system of claim 1, wherein the first arrival time is for a time after a scheduled time to start the event in the event scheduling information, wherein the first schedule comprises the scheduled time to start the event, and wherein the event schedule determining module determines an offer for at least one of a first showing of a same event after the event and a second showing of a similar event after the event and communicates the offer to the first user.

8. The system of claim 7, wherein the event schedule determining module offers to resell at least one ticket for the event purchased by the first user.

9. The system of claim 7, wherein the offer further comprises a sale of at least one ticket to at least one of the first showing and the second showing.

10. The system of claim 1, wherein the event schedule determining module provides an incentive to the first user if an actual arrival time for the first user is before a scheduled start time for the event in the event scheduling information.

11. The system of claim 1, wherein a venue hosts the event and comprises at least one wireless beacon device, and wherein the first user possesses a communication device, and wherein the communication device and the at least one wireless beacon device connect when the communication device is in proximity to the at least one wireless beacon device to generate the first location information for the first user.

12. The system of claim 1, wherein the communication module receives the first location information from the at least one wireless beacon.

13. The system of claim 12, the communication device and the at least one wireless beacon device connect using one of near field communication, radio communication, infrared communication, Bluetooth communication, Bluetooth Low Energy (BLE) communication, WiFi communication, and LTE Direct communication.

14. A method comprising:
accessing, by a scheduling module comprising at least one hardware processor, a first schedule for an event at a venue;
accessing, by the scheduling module, first attendance information for a first user attending the event at the venue;
processing, by the scheduling module, the first attendance information to determine a first arrival time for the first user at the venue;
processing, by the scheduling module, the first arrival time with the first schedule to determine a second schedule for the event; and
communicating, via a communication module, the second schedule to a scheduling device at the event.

15. The method of claim 14 further comprising:
providing, via a communication module, a benefit to at least one other user if the at least one other user is located at the event at a start time for the event in the first schedule.

16. The method of claim 15, wherein the benefit comprises at least one of a preshow for the event, a discount for a purchase at the venue, at least one additional ticket to one of the venue and a related event, and

17. The method of claim 14, wherein the first attendance information comprises a first playlist for the event entered by the first user, and wherein the second schedule comprises an event playlist determined using the first playlist.

18. The method of claim 17, wherein prior to the processing, by the scheduling module, the first arrival time with the first schedule to determine the second schedule, the method further comprises:
accessing second attendance information for a second user attended the event at the venue, wherein the second attendance information comprises a second playlist for the event entered by the second user;
wherein the event playlist is further determined using the second playlist.

19. The method of claim 18, wherein the event playlist comprises items from the second playlist before items from the first playlist if the first arrival time for the first user is after a second arrival time for the second user.

20. A non-transitory computer-readable medium comprising executable modules which, in response to execution by a computer system, cause the computer system to perform a method comprising:
accessing, by a scheduling module comprising at least one hardware processor, a first schedule for an event at a venue;
accessing, by the scheduling module, arrival information for a user at the venue;
processing, by the scheduling module, the arrival information to determine an arrival time for the user at the venue;
processing, by the scheduling module, the arrival time with the first schedule to determine a second schedule for the event; and
communicating, via a communication module, the second schedule to a scheduling device at the event.
